(19) United States
(12) Patent Application Publication
(10) Pub. No.: US 2002/0130951 A1
(43) Pub. Date: Sep. 19, 2002

(54) Stride length measurement device

(75) Inventor: Takehiro Kurono, Hamamatsu-shi (JP)

Correspondence Address: MORGAN LEWIS & BOCKIUS LLP, 1111 PENNSYLVANIA AVENUE NW, WASHINGTON, DC, 20004, US

(73) Assignee: HAMAMATSU PHOTONICS K.K.

(21) Appl. No.: 10/096,891

(22) Filed: Mar. 14, 2002

(30) Foreign Application Priority Data
Mar. 15, 2001 (JP) P2001-076435

(51) Int. Cl. H04N 7/18

(52) U.S. Cl. 348/61

(57) ABSTRACT

Markers 24 are provided on a belt 20 of a treadmill 10. A video camera 50 for stride length is used to pick up an image including the foot 2 of a subject 1 running or walking over the running surface 26 of belt 20 and also markers 24. Landing of foot 2 on belt 20 is detected using this image. The positional relationship of marker 24 and one foot 2 when this foot 2 lands and also the positional relationship of marker 24 and the other foot 2 when this foot 2 lands are respectively acquired. These two positional relationships are then used to acquire the stride length of subject 1. thereby it is possible to acquire the stride length directly and with high precision, irrespective of the speed of walking/running of subject 1 or the speed of belt 20.

### BACKGROUND OF THE INVENTION

1. Field of the Invention

The present invention relates to a stride length measurement device that measures stride length during running or walking.

2. Description of the Related Art

In recent years, in sports clubs etc, so-called treadmills have become popular in which physical training etc is performed by the subject walking/running over the running surface of a belt, which is driven with a suitable speed. The stride length of the subject who is walking/running on this treadmill is regarded as an important index for evaluating the walking/running attitude of the subject. Stride length measurement devices are therefore known in which the stride length of a subject walking/running on a treadmill is acquired from the relationship between the time interval with which the feet land on the belt and the running speed of the belt and thus acquired stride length is displayed, for example as disclosed in Japanese Utility Model Publication No.H7-45239.

### SUMMARY OF THE INVENTION

However, with a stride length measurement device as described above, the construction is complicated and costs are increased by the need to provide in the treadmill sensors for measurement of belt running speed and for measurement of the time interval with which the feet land. A further problem was that accuracy of the measuring stride length was poor owing to the need to find the stride length indirectly from the belt running speed and the time interval with which the feet land.

The present invention was made in view of the foregoing, its object being to provide a stride length measurement device capable of measuring stride length with high accuracy while yet having a straightforward construction.

A stride length measurement device according to the present invention for measuring stride length of a subject running or walking over a floor surface comprises: a marker arranged on the floor surface; image pickup means that picks up an image including the marker and a foot of the subject; and stride length measurement means that, using the image that has thus been picked up, detects landing on the floor surface of one foot and acquires the positional relationship of this foot and the marker when the foot lands, and also detects landing on the floor surface of the other foot and acquires the positional relationship of this foot and the marker when this foot lands, and acquires the stride length of the subject on the basis of these two positional relationships.

With the stride length measurement device of the present invention, an image including a marker and the foot of the subject running or walking over the floor surface is picked up and landing of the foot on the floor surface is detected using this image; in addition, the positional relationship of one foot and the marker when this foot lands and the positional relationship of the other foot and the marker when this foot lands are respectively acquired and the stride length of the subject is acquired using these two positional relationships; in this way, the stride length is acquired directly and with high precision irrespective of the speed of walking or running and of the speed of the floor surface. Also, lowering of the cost of the equipment can be achieved, since a straightforward construction is adopted in which the stride length is acquired from the image without employing a sensor etc.

In addition, preferably a plurality of markers are arranged with a prescribed interval in the direction of running or walking of the subject on the floor surface.

In this way, by selecting the marker, which is close to the foot of the subject in the image, the positional relationship between the one foot and the other foot can be acquired using this marker, thereby increasing the precision of the acquired stride length.

Also, preferably, the stride length measurement means, using the image that has thus been picked up, detects landing on the floor surface of one foot and acquires the positional relationship of this foot and one of the markers when this foot lands, and also detects landing on the floor surface of the other foot and acquires the positional relationship of this foot and another marker when this foot lands, and acquires the distance between two of the markers which have been used for respectively acquiring two positional relationships, and acquires the stride length of the subject on the basis of two positional relationships and the distance between two of the markers.

In this way, when the positional relationships of the foot are acquired, it is possible to acquire the stride length based on the positional relationships using markers that are mutually different for the one foot and the other foot so, in acquiring the positional relationships, the markers that are nearest to the respective feet of the subject in the image can be used; thus the stride length can be acquired even more precisely.

Preferably, the floor surface is the running surface of an endless belt driven with prescribed speed.

In this way, the stride length of the subject running or walking over the endless belt is measured irrespective of the drive speed of the endless belt or the walking/running speed of the subject.

Preferably, the image pickup means picks up the images at prescribed time interval and its range of image pickup is fixed with respect to the running surface.

In this way, in each image that is picked up by the image pickup means, the markers on the endless belt move with prescribed speed in a fixed direction so the markers can easily be detected. Also the feet landing on the endless belt move in the same direction and with the same speed as the markers, so detection of the landing of a foot can easily be accomplished.

In addition, the image pickup means is preferably set up such that, in the image that is picked up, the drive direction of the running surface and one side of the outer frame of the image are parallel. In this way, detection of the markers and of landing of a foot is further facilitated.

Also, preferably, the markers are provided at interval longer than the distance of movement produced by driving of the endless belt in the prescribed time interval.

In this way, detection of the markers is further facilitated since a marker in the image at a given time cannot overtake another marker that is positioned ahead of this marker in moving direction in the image at the next time.

Also, the stride length measurement means preferably comprises: moving marker identification means that extracts a marker in the image, and by comparing the positions of markers in the image with the positions of markers in an image picked up prior to this image, associates markers between these two images, then confers the same identification number on the marker in the image as the corresponding marker in the image picked up prior to this image, and also confers a new identification number on the marker that has been newly picked up in the image; prescribed section detection means that detects the position of a prescribed section of the foot of the subject in the image; landing determination means that determines whether or not the foot of the subject has landed on the endless belt on the basis of the change over the time of the position of the prescribed section; landing position acquisition means that, when it is determined that the foot of the subject has landed on the endless belt, acquires, each time the foot lands, the positional relationship of the prescribed section and the marker in the image and the identification number of this marker; and stride length acquisition means that acquires the stride length of the subject by using the positional relationships respectively acquired on two adjacent landings and the distance between the markers used in acquiring the positional relationships, which were acquired based on the identification numbers of the respective markers and the prescribed interval with which the markers are arranged.

In this way, the stride length measurement device is suitably implemented since identification of the markers is reliably performed in each image.

Also, if display means is provided that displays the stride length that has been acquired, the acquired stride length can be easily grasped.

Also, preferably, there are provided an individual data storage section in which stride length data for each individual are stored, and a data comparison section wherein comparison is performed of the stride length data stored in the individual data storage section and the acquired stride length.

In this way, comparison can easily be effected of stride length data measured previously or stride length data etc of another person and the currently measured stride length data.

Also, preferably, there is further provided attitude image pickup means that picks up the running attitude or walking attitude of the subject from at least one or other direction of in front of the subject or to the side thereof. Attitude check can thereby be achieved simultaneously with stride length calculation.

### BRIEF DESCRIPTION OF THE DRAWINGS

FIG. 1 is a constructional diagram illustrating a stride length measurement device according to an embodiment;

FIG. 2 is a top view of the treadmill in FIG. 1;

FIG. 3 is a diagrammatic view illustrating an example of an image picked up by the video camera for stride length in FIG. 1;

FIG. 4 is a block diagram of a stride length measurement device according to the embodiment;

FIG. 5 is a flow chart illustrating the processing performed within the computer in FIG. 1;

FIG. 6 is a flow chart illustrating the processing of the moving marker identification step in FIG. 5;

FIG. 7A illustrates brightness value data acquired in step 51 of FIG. 6;

FIG. 7B is a view illustrating binary data acquired by processing the brightness value data of FIG. 7A in step 52 of FIG. 6;

FIG. 8A and B are views illustrating step 54 of FIG. 6,

FIG. 8A being a diagram illustrating a marker acquired in the (n)th frame and

FIG. 8B being a diagram illustrating a marker acquired in the (n−1)the frame;

FIG. 9 is a flow chart illustrating the processing in step 3 of FIG. 5;

FIGS. 10A to C are views illustrating step 62 and step 63 of FIG. 9,

FIG. 10A being a diagram illustrating the case where step 62 is performed initially on the image,

FIG. 10B being a diagram illustrating the case where step 62 is performed a second time on the image and

FIG. 10C being a diagram illustrating the case where step 63 is performed on the image;

FIG. 11 is a diagram illustrating the processing of step 4 and step 20 of FIG. 5;

FIG. 12 is a diagram illustrating the processing of step 7 of FIG. 5;

FIG. 13 is a diagram illustrating an example of the results of measurement displayed on the display in FIG. 1;

FIG. 14 is a diagram illustrating another example of the results of measurement displayed on the display in FIG. 1;

FIG. 15 is a diagram illustrating yet another example of the results of measurement displayed on the display in FIG. 1; and

FIG. 16 is a diagram illustrating another example of an image picked up by the video camera for stride length in FIG. 1.

### DESCRIPTION OF THE PREFERRED EMBODIMENTS

A preferred embodiment of a stride length measurement device according to the present invention is described in detail below with reference to the appended drawings. In the description of the drawings, identical or corresponding elements are given the same reference symbols without repeating their overlapping descriptions.

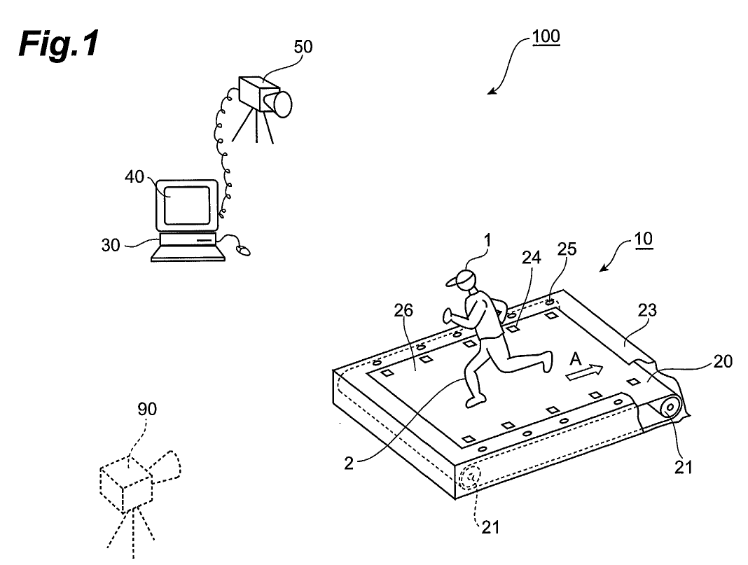

FIG. 1 is a constructional view illustrating a stride length measurement device 100 according to this embodiment. This stride length measurement device 100 comprises a treadmill 10 equipped with a belt (endless belt) 20, a video camera 50 for stride length, acting as an image pickup means, that picks up at prescribed fixed time intervals an image of this treadmill 10 and the feet 2 of the subject 1 running or walking over the treadmill 10, a computer 30 that acquires the stride length of subject 1 using this image that has been picked up, and a display 40 that displays the acquired stride length.

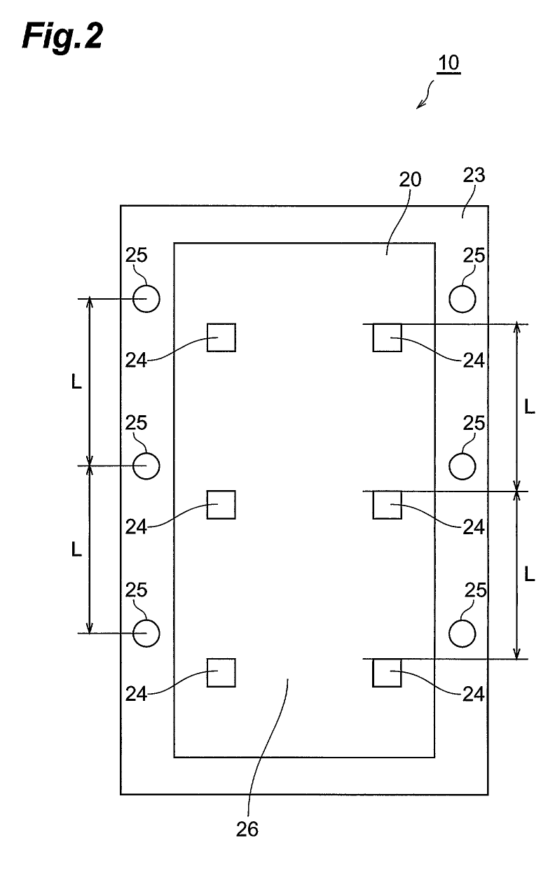

Treadmill 10 comprises an endless belt 20 stretched over a pair of rollers 21, 21 arranged parallel to each other. Belt 20 is driven in circulating fashion in the direction A in the drawing with prescribed speed by one of rollers 21 being driven by a drive device, not shown. The upper surface of this belt 20 functions as a running surface 26 that is mounted by subject 1 and over which running or walking is performed in the opposite direction to drive direction A, matching the drive speed of belt 20. Also, the outer circumferential face of this belt 20 is provided with markers 24 as shown in FIG. 2. A plurality of markers 24 are respectively provided with a fixed interval L along the drive direction A at both edges of the outer circumferential surface of belt 20; however, they could be provided at only one of these edges. Preferably, markers 24 have a brightness that is considerably different from the brightness of belt 20.

Interval L is made longer than the distance through which a marker 24 moves along the running surface 26 in a prescribed time interval of video camera 50 for stride length. The time interval of image pickup by video camera 50 for stride length adopted in this embodiment is 33 ms and the maximum speed of running surface 26 is set at 30 km/h, so preferably the distance L between markers 24 is set at at least 27.5 cm; in this embodiment L=60 cm is chosen, being a distance which is about twice this.

Also, as shown in FIG. 1, belt 20 is covered by a box-shaped cover 23 provided with a rectangular aperture through which only the running surface 26 is exposed, in the center of its upper surface. Fixed markers 25 arranged with interval L along the drive direction A like markers 24 are arranged as shown in FIG. 2 in positions adjacent to markers 24 of running surface 26 at the upper face of this cover 23.

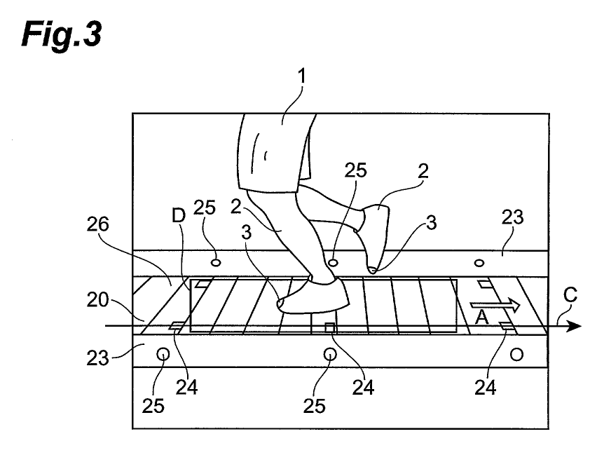

As shown in FIG. 1, video camera 50 for stride length is arranged so as to perform image pickup from the side of a treadmill 10, the direction of this image pickup being orthogonal to the drive direction A. Also, video camera 50 for stride length is arranged in a position higher than running surface 26. As shown in FIG. 3, this video camera 50 for stride length is set so as to include in its image markers 24 on running surface 26 and feet 2 of subject 1 walking or running over running surface 26 and such that running surface 26 is arranged parallel with the bottom edge of the image.

Also, the range of image pickup is fixed with respect to the running surface 26 of treadmill 10. Consequently, when belt 20 is driven with constant speed, markers 24 move with constant speed and in the horizontal direction to the drive direction A.

Also, the image pickup range is set such that at least one respective group of fixed marker 25 is picked up on the front side and the backside of cover 23.

Consequently, conversion of the distance on the screen into the actual distance is performed based on the distance on the screen between these fixed markers 25 and the actual distance L between fixed markers 25, which is set beforehand.

A line is set up beforehand in the horizontal direction on the screen in the region through which markers 24 on running surface 26 pass and this is designated as marker extraction line C. Also, a region in which it is expected that the leading end (prescribed portion) 3 of a foot 2 will be present when the foot 2 of subject 1 lands on running surface 26 is set up on the screen and this is designated as foot leading end extraction region D.

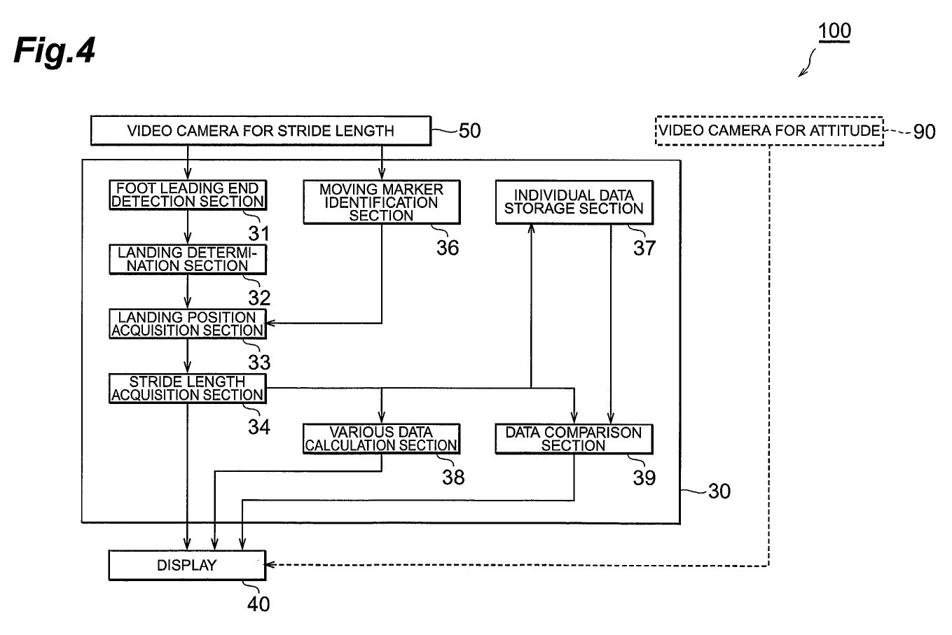

As shown in FIG. 4, computer 30 comprises foot leading end detection section 31, landing determination section 32, landing position acquisition section 33, stride length acquisition section 34, moving marker identification section 36, individual data storage section 37, various data calculation section 38 and data comparison section 39.

Foot leading end detection section 31 detects the position of the foot leading end 3 of subject 1 by sequentially acquiring images picked up by video camera 50 for stride length. Landing determination section 32 ascertains whether or not the foot leading end 3 that has been detected has landed on running surface 26. Moving marker identification section 36 sequentially acquires images picked up by video camera 50 for stride length; identifies a marker 24; compares the position of this marker 24 with the position of the marker 24 in the image picked up at the previous time; associates markers 24 between the two images; it then attaches to the marker 24 in this image the same identification number as the corresponding marker 24 in the image that was previously picked up; and attaches a new identification number to the marker 24 that is newly picked up. Landing position acquisition section 33 acquires the distance in the drive direction A of running surface 26 of foot leading end 3 and marker 24 in the image when it is ascertained that the foot leading end 3 has landed on running surface 26, and acquires the identification number of this marker 24.

Using the distances between the foot leading end 3 and marker 24 at two adjacent landing points and the distance between these markers 24 obtained based on the identification numbers of the respective markers 24 referenced at their landing points, stride length acquisition section 34 acquires the stride length of subject 1. Various data calculation section 38 acquires data such as the stride time from the stride length data etc. Individual data storage section 37 stores stride length data etc for each individual. Data comparison section 39 acquires comparison data by comparing the stride length data stored in individual data storage section 37 and the stride length data acquired by the stride length acquisition section 34.

Display 40 displays data output from stride length acquisition section 34, various data calculation section 38 and data comparison section 39 and is arranged in a position where it can be viewed by subject 1 while the subject 1 is running or walking over the running surface 26.

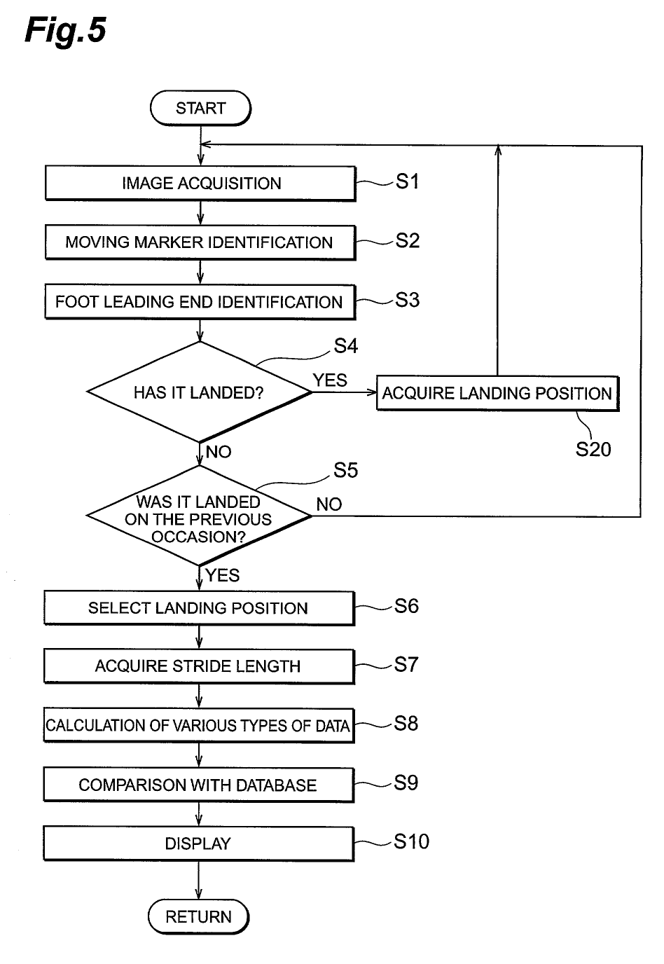

Next, the sequence of processing executed by computer 30 will be described with reference to the flow chart shown in FIG. 5.

Belt 20 of treadmill 10 is driven with prescribed speed and subject 1 starts running or walking over the running surface 26 of belt 20. And then image pickup by video camera 50 for stride length is commenced.

First of all, in step 1 (SI) the image (see FIG. 3) picked up by video camera 50 for stride length is input to computer 30 and designated as the (n)th frame.

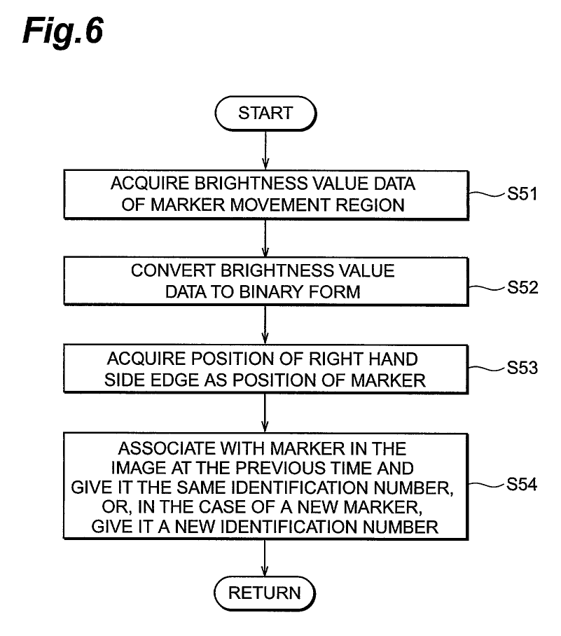

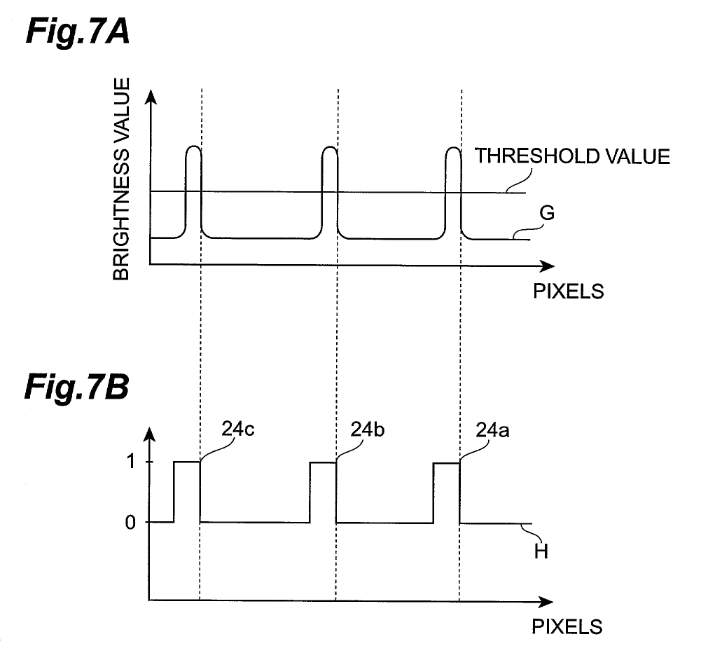

Next, in step 2 (S2), marker 24 in the image is detected and associated with the marker 24 in the previous image, and identification numbers are given to the respective markers. Step 2 will be described in detail referring to the flow chart of FIG. 6. First of all, in step 51 (S51), change of brightness value data G as shown in FIG. 7A are obtained by scanning the pixels on marker extraction line C (line C in FIG. 3) that was set up beforehand in a region through which markers 24 in the image pass. Further, in step 52 (S52), binary data H are obtained as shown in FIG. 7B in which the pixels of marker 24 and pixels other than this are separated, by converting the change of brightness data G to binary form based on a prescribed threshold value. In cases where it is difficult to extract markers 24 by processing to convert to binary form because of reflection etc of belt 20, markers 24 may be extracted using the differentiated values of change of brightness data G.

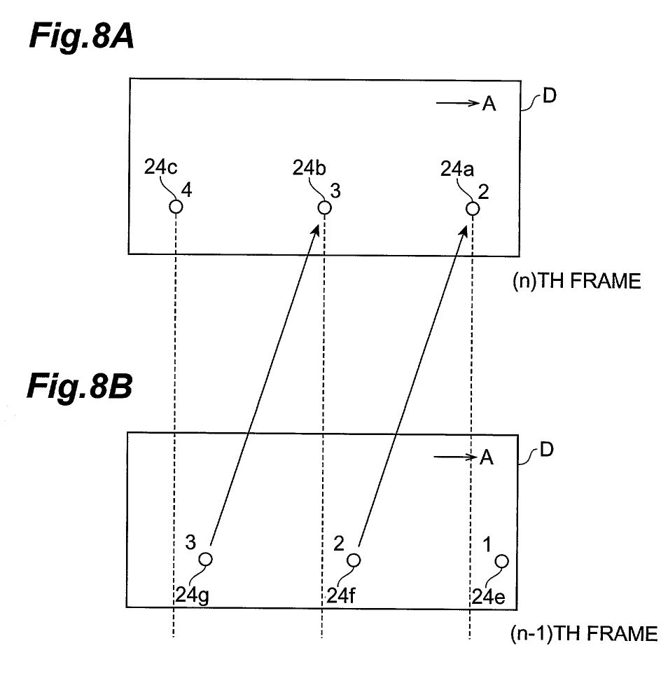

Then, in step 53 (S53), the right-hand edges of the peaks of this binary data H indicating the markers are extracted as the positions of the respective markers 24a, 24b, 24c (see FIG. 7B) and these are stored as the positions of markers 24a, 24b, 24c of the n(th) frame (see FIG. 8A). In this process, the coordinates of the left-hand side edge or of the center of the peak may be employed. Also, for the threshold value, a value is chosen so as to permit separation of markers 24 and belt 20: for example, a value intermediate between the maximum value and minimum value of the change of brightness data G may be employed. Also, apart from the brightness value, change of color information such as the saturation value or lightness value of the pixels could be acquired, thereby converting this to the binary form to acquire the positions of markers 24.

Next, in step 54 (S54) of FIG. 6, association with the markers 24e, 24f, 24g acquired in the (n−1)th frame (see FIG. 8B) which is the image of the previous time is performed. In this process, a marker 24f is found in the (n−1)th frame between positions of a pair of adjacent markers 24a, 24b in the (n)th frame, and then it is ascertained that marker 24f in the (n−1)th frame has moved to marker 24a in the (n)the flame which is on the side of drive direction A of belt 20 of the pair of adjacent markers 24a, 24b. The identification number 2 which is already possessed by marker 24f is conferred as the identification number of marker 24a in the (n)th frame. Also, likewise, marker 24g in the (n−1)th frame is associated with marker 24b in the (n)th frame and the identification number 3, which is the identification number of marker 24g corresponding to marker 24b, is conferred on marker 24b. Further, marker 24c in the (n)th frame, for which no corresponding marker 24 can be found in the (n−1)th frame, is deemed to be a newly appearing marker and then is given the new identification number 4.

In this way, newly appearing markers are given new identification numbers and respective markers 24 in adjacent two flame are associated so that the same markers 24 are given the same identification numbers; thus, the distance of arbitrary extracted two markers 24 on running surface 26 of belt 20 can easily be acquired by using the identification numbers of the respective markers 24 (for example, by taking the difference) and the interval L with which markers 24 are arranged. Also, association between markers 24 in adjacent two images is facilitated by the fact that the interval L is made longer than the distance which a marker 24 moves over the running surface 26 in a prescribed time which is the image pickup interval of video camera 50 for stride length, so that a marker 24 cannot pass by the position of another marker 24 of an image picked up at a particular time in the image picked up at the next time. This therefore makes it easy to associate the markers 24 among different images.

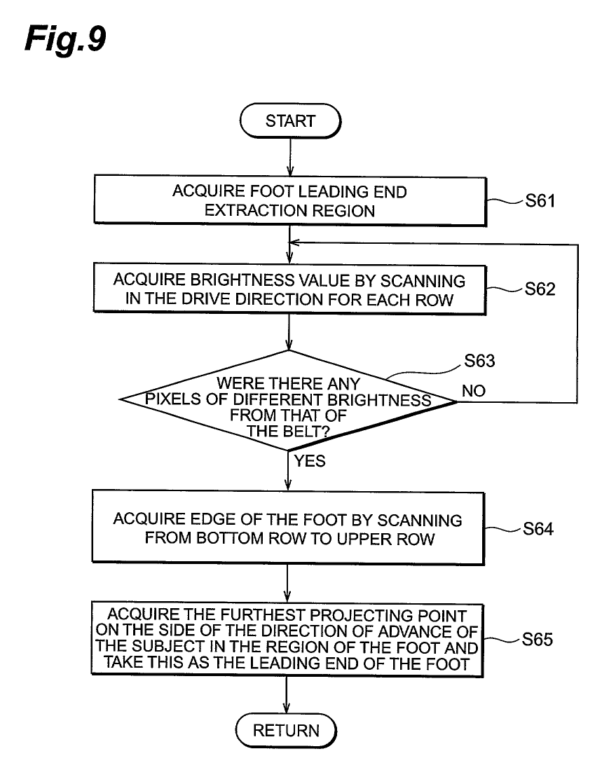

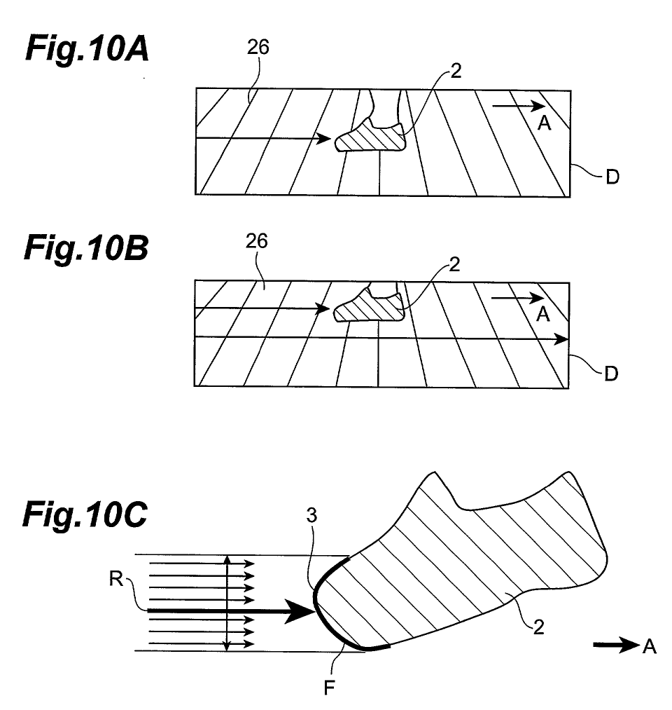

Next, in step 3 (S3) of FIG. 5, detection of the co-ordinates of the leading end 3 of the foot 2 is performed. First of all, in step 61 (S61) as shown in the flow chart of FIG. 9, from the image acquired in step 1, the foot leading end extraction region D (see FIG. 3) that was set up beforehand in the image as the region where the image of the leading end 3 of foot 2 is expected to be picked up when the foot 2 of the subject 1 landed on the running surface 26 of belt 20 is extracted. Then, in step 62 (S62), as shown in FIG. 10A, the brightness value of each pixel is obtained by scanning this foot leading end extraction region D in the drive direction (direction A in the drawing) from the left-hand end in the Figure.

Next, in step 63 (S63), the brightness value of each pixel obtained by scanning is compared with the average brightness value of belt 20 that was set beforehand. Then, if the difference in brightness value from that of belt 20 does not exceed the prescribed threshold value, this pixel is deemed to be a pixel of belt 20, not of foot 2 and processing returns to step 62 in which the brightness of the pixel further on the right-hand side is examined; when all pixels of relevant row have thus been scanned, the brightness values of a different row of foot leading end extraction region D are likewise examined in sequence from the left-hand side.

In this process, in step 62, it would be possible to scan in sequence from the uppermost row to the lowermost row, but foot 2 can be discovered more efficiently by scanning first the middle row (see FIG. 10A) then scanning a middle row of the remaining rows (see FIG. 10B).

In step 63, if it is found that the difference of the brightness value of the pixel acquired in step 62 from the prescribed brightness value of belt 20 exceeds the prescribed threshold value, this pixel is deemed to be a pixel constituting the region of foot 2 and processing advances to step 64 (S64).

Next, in step 64, as shown in FIG. 10C, the edge F on the rear side of the drive direction A of running surface 26 i.e. on the side of the direction of advance of subject 1 in the region of the foot 2 is acquired by sequentially scanning rows R above and below where foot 2 was found. Then, in step 65 (S65), the point on this edge F, which is furthest in the direction of advance of subject 1, is identified as the leading end 3 of the foot and its co-ordinates are acquired. It should be noted that, in this step 3, it would be possible to detect the leading end 3 of the foot using color information such as the hue or saturation value instead of the brightness value.

Next, in step 4 (S4) of FIG. 5, a determination is made as to whether or not the leading end 3 of the foot has landed. In this process, the changes of coordinates of the leading end 3 respectively acquired in the images of the (n−2)th frame two periods previously, of the (n−1)th frame immediately previous and of the current (n)th frame are examined and, if the leading end 3 of the foot is moving with practically fixed speed in the drive direction A of belt 20 and the leading end 3 of the foot is scarcely moving in the direction perpendicular to the running surface 26, it is deemed to have landed.

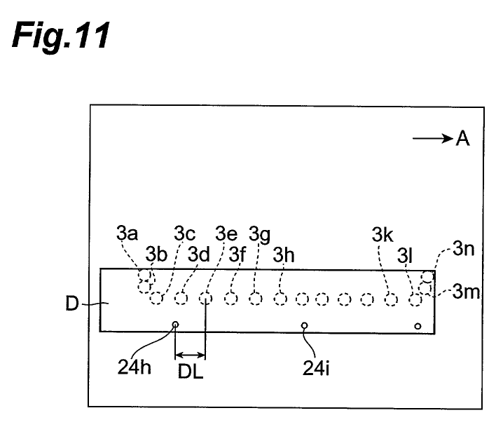

For example, as shown in FIG. 11, if the leading end of the foot in the (n)th frame is foot leading end 3e, the leading end of the foot in the (n−1)th frame is foot leading end 3d, and the leading end of the foot in the (n−2)th frame is foot leading end 3c, foot leading end 3 is moving with practically fixed speed in the drive direction A of running surface 26 and the leading end of the foot is scarcely moving in the direction perpendicular to the running surface 26, so this foot leading end 3e is concluded to have landed.

It should be noted that, for this conclusion, for simplicity, it would be possible to adopt only one or other of the criteria: that the foot leading end 3 is moving with practically constant speed in the drive direction A of running surface 26 or that foot leading end 3 is scarcely moving at all in the direction perpendicular to the running surface 26.

Then, if it is concluded that the foot leading end 3e has landed, processing advances to step 20 (S20) of FIG. 5 and a search is made for marker 24h which is nearest to this foot leading end 3e, and the distance DL in the drive direction A on the screen between foot leading end 3c and marker 24h (see FIG. 11) is acquired as the positional relationship of foot leading end 3e and marker 24h and the identification number of marker 24h is also acquired. Processing then again returns to step 1 in which detection of markers 24 etc is performed for a new image.

It should be noted that, since the loops of steps 1, 2, 3, 4, 20 are repeated a plurality of times between the landing and departure of one foot leading end 3 with respect to running surface 26, the data of the distance of foot leading end 3 and marker 24 and the identification number of marker 24 are obtained over a plurality of foot leading ends 3c (see FIG. 11) to 31 in respect of landing of a single foot 2.

In the other case, in step 4, if the above conditions are not fulfilled, it is concluded that the foot has not landed. For example (see FIG. 11) in the case where the foot leading end of the (n)th frame is foot leading end 3m, the foot leading end of the (n−1)th frame is foot leading end 3l, and the foot leading end of the (n−2)th frame is foot leading end 3k, since foot leading end 3 is not moving with fixed speed with regard to drive direction A and is moving in the direction perpendicular to the running surface 26, it is concluded that this foot leading end 3m has not landed. Also, for example in the case where the foot leading end of the (n)th frame is foot leading end 3c, the foot leading end of the (n−1)th frame is foot leading end 3b and the foot leading end of the (n−2) frame is foot leading end 3a, it is likewise concluded that this foot leading end 3c has not landed. If it is concluded that the foot does not landed, processing advances to step 5 (S5) of FIG. 5.

In step 5, whether the foot leading end 3 had landed or not in the processing of the preceding frame is ascertained; if it had not landed, it is concluded that foot leading end 3 is in the course of movement through the air (for example in the case where the foot leading end that is the current subject of processing is foot leading end 3b, 3n etc in FIG. 11) and processing returns to step 1.

In contrast, if the foot leading end 3 in the previous frame processing had landed (for example in the case where the foot leading end that is the current subject of processing is foot leading end 3m in FIG. 11), it is concluded that landing was completed and that foot leading end 3 has now started to rise, and processing advances to step 6.

In step 6 (S6), one of the sets of data of distance between foot leading end 3 and marker 24 and identification number of marker 24 respectively acquired in regard to foot leading ends 3c to 31 in respect of one foot 2 that has currently landed, which data is believed to be the most accurate, is selected. In this case, for example the data when foot leading end 3 of subject 1 is positioned in the vicinity of the middle of the image picked up by video camera 50 for stride length, namely the data in the case of foot leading end 3h, is considered to be the most accurate since there is no image distortion, so this data, being the distance between foot leading end 3h and marker 24 and the identification number of relevant marker 24, is selected and acquired. It should be noted that, instead of the data of the foot leading end 3 which is in the middle of the image, for example the average of the data of a plurality of foot leading ends 3c to 31 could be taken. It should further be noted that the position which is obtained on the screen may be somewhat offset from the position on belt 20, so correctional processing of this amount is performed. That is, the subsequent processing is performed after converting the positions which were obtained into positions on belt 20 in all cases.

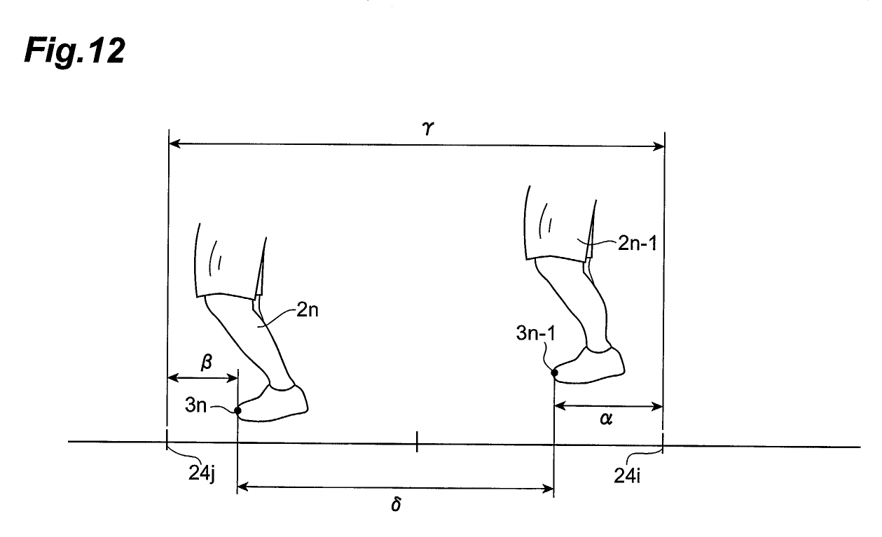

Next, acquisition of stride length is performed in step 7 (S7). Thereupon, first of all, as shown in FIG. 12, the distance between the foot leading end 3n−1 and the marker 24i and the identification number of the marker 24i acquired in respect of the other foot 2n−1 which landed previously, and distance between the foot leading end 3n and the marker 24j and the identification number of the marker 24j acquired in respect of the currently landing one foot 2n are fetched and the actual distance y between these markers 24i, 24j is found using the difference of the identification numbers of marker 24i and marker 24j and the actual interval L of markers 24. Next, the distance on the screen between marker 24i and foot leading end 3n−1 and the distance on the screen between marker 24j and foot leading end 3n are respectively converted to actual distance by using the conversion coefficient of distance on the screen into that of actual distance which is set beforehand, and the actual distance a between marker 24i and foot leading end 3n−1 and the actual distance β between marker 24j and foot leading end 3n are thereby found and, by addition/subtraction of these distance α, β and γ, the actual stride length δ between the previous landing position and the current landing position is found directly and with high precision.

Next, in step 8 (S8), calculation of various types of data is performed as required. For example, the drive speed of the belt 20 can be acquired by dividing the movement distance between frames of a marker 24 by the prescribed time of video camera 50 for stride length; the stride time, which is the time taken for a single stride can be acquired by (stride length)/(drive speed of belt 20); and the pitch, which is the number of strides per second, can be acquired by 1/(stride time), respectively. Also, the floating time can be acquired by acquiring the number of frames in the condition (floating in the air) in which the leading end of the foot is not in contact with the running surface 26 of belt 20 and the ground-engaging time can be acquired by (stride time)-(floating time), respectively.

Next, in step 9 (S9), the acquired stride length data are compared with other data. Therein, acquired stride length data etc are stored in individual data storage section 37 for each individual. The individual's own former data stored in individual data storage section 37, data of other people or standard data etc are compared with the currently measured stride length data etc. In this way, comparison of the currently measured stride length data with previously measured stride length data or other people's stride length data etc can easily be performed and the benefits etc of correcting stride length can easily be ascertained.

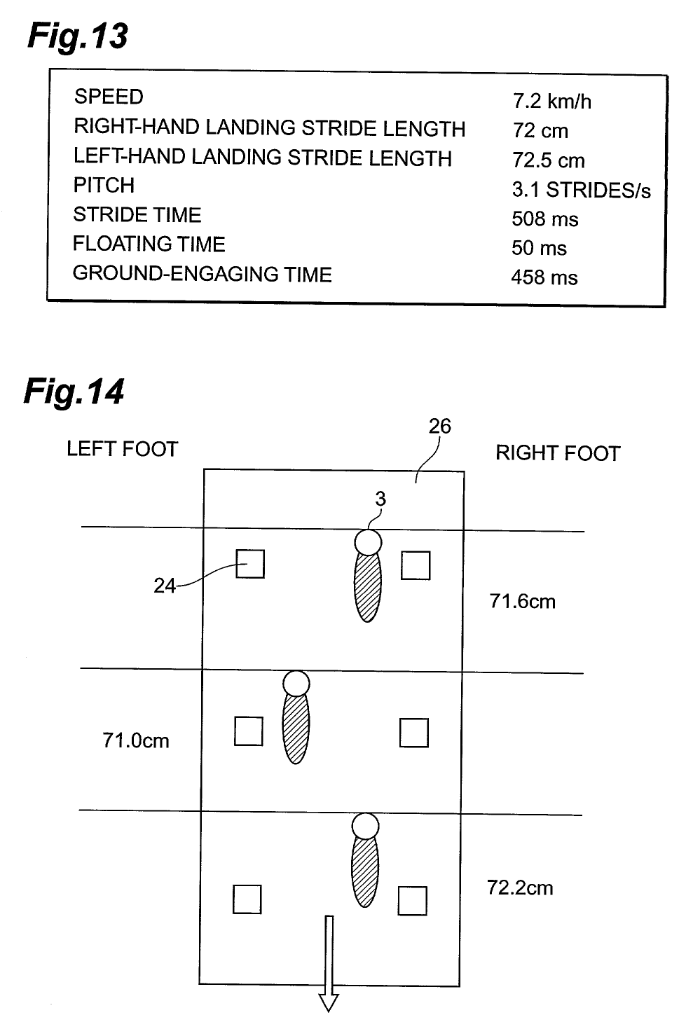

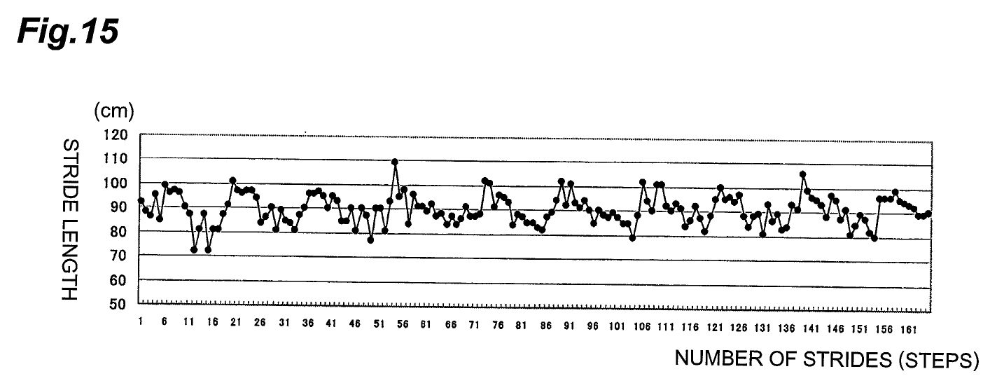

Next, in step 10 (S10), the stride length data etc is output and displayed on display 40. An example of the screen which is then produced is shown in FIG. 13. In this way, the stride length which has been acquired can easily be grasped by the subject. Also, as shown in FIG. 14, the stride length of each stride can be displayed by animation. Furthermore, as shown in FIG. 15, changes in stride length over time can be displayed by a graph. This graph shows the case of the acceleration/deceleration while jogging at a speed of 11 km/h; thus the increase and decrease of stride length produced by acceleration/deceleration can easily be grasped.

Also, the comparison data obtained by the comparison in step 9 can likewise be displayed on the screen. These comparison results can then be output by sound or light etc or the evaluation of walking/running data may be achieved by mapping such data.

Also, as shown in FIG. 1, a video camera 90 for attitude may be provided to pick up a front view, side view or rear view etc of the attitude of the running/walking subject, and this image may be simultaneously displayed on display 40. In this way, the running/walking attitude and the stride length may be simultaneously grasped by the subject 1.

When such outputting of stride length etc is completed, the process return to step 1 and landing etc of the other foot 2 can be detected. In this way, data of stride length can be continuously obtained at each stride and detailed data concerning change over time of the stride length and change of pace etc can be acquired.

In this way, with the stride length measurement device 100 according to this embodiment, an image is picked up including the foot 2 of the subject 1 running or walking over the running surface 26 of belt 20 and marker 24, and landing of foot 2 on belt 20 is detected using this image; then, by respectively acquiring the positional relationship of the foot 2 in question and marker 24 when one foot 2 has landed and the positional relationship of the foot 2 in question and marker 24 when the other foot 2 has landed; and directly acquiring the stride length of subject 1 by using both of these positional relationships, the stride length can be acquired directly and with high accuracy irrespective of the speed of walking/running or the speed of the floor surface. Also, lowering of the cost of the equipment can be achieved, since a straightforward construction is adopted in which the stride length is acquired from an image without employing a sensor etc.

In addition, since a plurality of markers 24 are arranged with a prescribed interval in the direction of running etc of the subject 1 on the outer circumferential surface of belt 20, the marker 24 which is closest to foot 2 of subject 1 in the image is selected and the positional relationship between the one foot 2 and the other foot 2 can be acquired using this marker 24, thereby increasing the precision of the acquired stride length.

Also, computer 30, using the image that has thus been picked up, detects landing on belt 20 of one foot 2 and acquires the positional relationship of the foot 2 in question and marker 24 when this foot 2 lands and also detects landing on the belt of the other foot 2 and acquires the positional relationship of the foot 2 in question and marker 24 when this foot 2 lands and furthermore acquires the distance between the markers 24 used when respectively acquiring these two positional relationships and acquires the stride length of subject 1 by using these two positional relationships and the distance between markers 24, so, by using markers 24 that are mutually different for one foot 2 and the other foot 2, the positional relationships can be acquired using the markers 24 that are nearest to the respective feet 2 in the image; thus the stride length can be measured even more precisely.

Also, since video camera 50 for stride length performs image pickup at prescribed time interval and its range of image pickup is fixed with respect to running surface 26, the positions of markers 24 on belt 20 move with prescribed speed in a fixed direction and so markers 24 can easily be identified. Also since feet 2 landing on belt 20 move in the same direction and with the same speed as markers 24, detection of the landing of a foot 2 can easily be accomplished.

In addition, since video camera 50 for stride length is set up such that, in the image that is picked up, the drive direction of running surface 26 and one side of the outer frame of the image are parallel, identification of markers 24 and determination of landing of a foot 2 is further facilitated.

It should be noted that a stride length measurement device according to the present invention is not restricted to the embodiment described above but could be modified in various ways. For example, although, in this embodiment, the running surface 26 of belt 20 of treadmill 10 was chosen as the floor surface, there is no restriction to this and a fixed surface such as that of a floor surface or the ground could be employed.

Also, although, in this embodiment, a plurality of markers 24 were provided on belt 20, it would be possible to provide only a single marker. In this case, video camera 50 for stride length can perform image pickup with this marker 24 and foot 2 being arranged to be always covered thereby, from landing of one foot 2 until landing of the other foot 2. Also, since there is only a single marker 24, the stride length is acquired using only the distance between this marker 24 and the leading end 3 of foot 2 when the one foot 2 lands and the distance between this marker 24 and the other leading end 3 of foot 2 when the other foot 2 lands, without finding the distance between markers 24.

In addition, although, in this embodiment, video camera 50 for stride length was set up such that its range of image pickup was fixed with respect to the running surface 26 of belt 20, in order to facilitate identification and association of markers 24 and detection of foot leading end 3, there is no restriction to this. The image pickup range of video camera 50 for stride length may be moved matching movement of subject 1 such that the foot 2 of subject 1 is captured within the image, for example in cases where the subject is not running or walking with a speed to cancel the speed of drive of belt 20. In this case, since the movement of marker 24 on the screen does not take place with fixed speed/fixed direction, determination of landing cannot be performed based solely on the movement of the leading end 3 of the foot on the screen but may be performed based on the relative movement of the foot leading end 3 and marker 24 on the screen (for example when the relative speed has become practically zero).

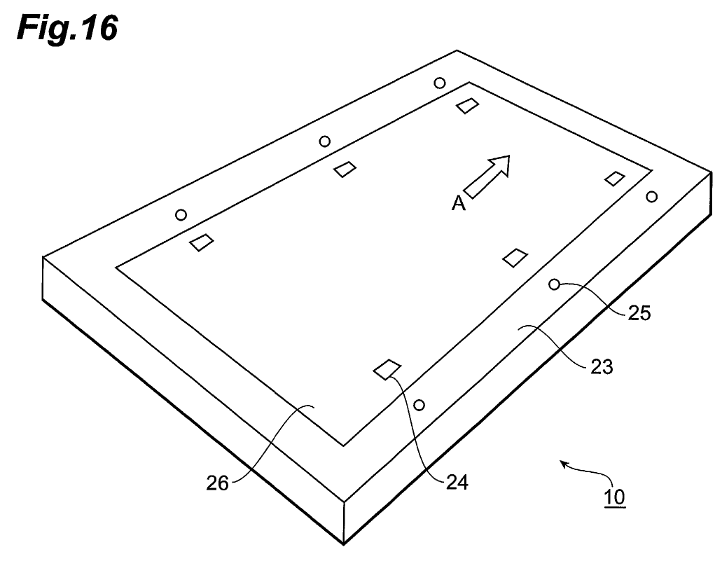

Also, although, in this embodiment, running surface 26 was arranged parallel with the edge of the image, there is no restriction to this. For example, as shown in FIG. 16, it could be in a non-parallel arrangement. In this case, the actual distance can be acquired from the distance on the screen in the same way, by performing co-ordinate transformation etc.

Also, although, in this embodiment, in order to achieve easy association of markers 24 between images, the separation of markers 24 was set to be longer than the distance a marker 24 moves along running surface 26 in the prescribed time interval of image pickup, it could be set to be shorter than this. In this case, identification and association of markers 24 between images is made possible for example by providing a difference in color or size etc between adjacent markers 24.

Also, although, in this embodiment, a display 40 was provided to display the measurement results, there is no restriction to this and the results could be printed using a printer etc.

Also, although, in this embodiment, the stride length data obtained by stride length measurement device 100 were arranged to be fully utilized for training etc by the provision of an individual data storage section 37, data comparison section 39, various data calculation section 38 and video camera 90 for attitude, it would be possible to acquire the stride length data without providing these.

Also, although, in this embodiment, the leading end 3 of the foot was selected as the prescribed section of the foot, there is no restriction to this and the heel, pattern of the shoe or an extra marker provided on foot 2 etc could be employed.

What is claimed is:

1. A stride length measurement device for measuring stride length of a subject running or walking over a floor surface, comprising:
a marker arranged on said floor surface;
image pickup means that picks up an image including said marker and a foot of said subject; and
stride length measurement means that, using said image that has thus been picked up, detects landing on said floor surface of one foot and acquires the positional relationship of this foot and said marker when the foot lands, and also detects landing on said floor surface of the other foot and acquires the positional relationship of this foot and said marker when this foot lands, and acquires the stride length of said subject on the basis of these two positional relationships.

2. The stride length measurement device according to claim 1, wherein a plurality of said markers are arranged on said floor surface with prescribed interval in the direction of running or walking of said subject.

3. The stride length measurement device according to claim 2, wherein said stride length measurement means, using said image that has thus been picked up, detects landing on said floor surface of one foot and acquires the positional relationship of this foot and one of said markers when this foot lands, and also detects landing on said floor surface of the other foot and acquires the positional relationship of this foot and another said marker when this foot lands, and acquires the distance between two of said markers which have been used for respectively acquiring said two positional relationships, and acquires the stride length of said subject on the basis of said two positional relationships and the distance between said two of said markers.

4. The stride length measurement device according to claim 2, wherein said floor surface is the running surface of an endless belt driven with prescribed speed.

5. The stride length measurement device according to claim 4, wherein said image pickup means picks up said images at prescribed time interval and its range of image pickup is fixed with respect to said running surface.

6. The stride length measurement device according to claim 5, wherein said image pickup means is set up such that the drive direction of said running surface in said image that is picked up and one side of the outer frame of said image are parallel.

7. The stride length measurement device according to claim 5, wherein said markers are provided at intervals longer than the distance of movement produced by driving of said endless belt in said prescribed time interval.

8. The stride length measurement device according to claim 5, wherein said stride length measurement means further comprises:
moving marker identification means that extracts a marker in said image, and by comparing the positions of markers in said image with the positions of markers in an image picked up prior to this image, associates markers between these two images, then confers the same identification number on the marker in said image as the corresponding marker in the image picked up prior to this image, and also confers a new identification number on the marker that has been newly picked up in said image;
prescribed section detection means that detects the position of a prescribed section of the foot of said subject in said image;
landing determination means that determines whether or not the foot of said subject has landed on said endless belt on the basis of the change over the time of the position of said prescribed section;
landing position acquisition means that, when it is determined that the foot of said subject has landed on said endless belt, acquires, each time said foot lands, the positional relationship of said prescribed section and the marker in said image and the identification number of this marker; and
stride length acquisition means that acquires the stride length of said subject by using said positional relationships respectively acquired on two adjacent landings and the distance between the markers used in acquiring said positional relationships, which were acquired based on the identification numbers of the respective markers and said prescribed interval with which said markers are arranged.

9. The stride length measurement device according to claim 1, further comprising display means that display said measured stride length.

10. The stride length measurement device according to claim 1, further comprising; an individual data storage section, in which stride length data for each individual are stored; and a data comparison section wherein comparison is performed of the stride length data stored in said individual data storage section and said measured stride length.

11. The stride length measurement device according to claim 1, further comprising an image pickup means for attitude that picks up the running attitude or walking attitude of said subject from at least one or other direction of in front of said subject or to the side thereof.
